(19) United States
(12) Patent Application Publication
(10) Pub. No.: US 2009/0024926 A1
(43) Pub. Date: Jan. 22, 2009

(54) Portable information terminal

(75) Inventor: Shiro Morotomi, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/218,462

(22) Filed: Jul. 15, 2008

(30) Foreign Application Priority Data
Jul. 17, 2007 (JP) JP2007-185561

(51) Int. Cl. G06F 3/048; G06F 3/02; G06F 1/16

(52) U.S. Cl. 715/716; 345/169; 361/680

(57) ABSTRACT

Disclosed herein is a portable information terminal in which a second housing is slidingly arranged for a first housing, including: an operation key arranged on a plane of the second housing that is exposed when the second housing is put in an open status relative to the first housing by a sliding movement in one direction; and a special key arranged in a predetermined area on another direction side opposite to the one direction on the plane.

### CROSS REFERENCES TO RELATED APPLICATIONS

The present invention contains subject matter related to Japanese Patent Application JP 2007-185561 filed in the Japan Patent Office on Jul. 17, 2007, the entire contents of which being incorporated herein by reference.

### BACKGROUND OF THE INVENTION

1. Field of the Invention

The present invention relates to a portable information terminal configured to execute a predetermined interrupt processing by operating a special key.

2. Description of the Related Art

In the past, high-level information processing is practicable with portable information terminals, such as the PDA (Personal Digital Assistant). Today, these portable information terminals are capable of reproducing various kinds of content, such as music and images, for example. These various kinds of content are appropriately downloadable via external networks by wireless communications functions of these portable information terminals.

For users who often reproduce various kinds of content downloaded from the outside, the frequency of use of keyboards can be said to be low. On the other hand, for users who often execute electronic mailing and chats, for example, it can be said that the frequency of use of keyboards is high. In addition to these situations, portable information terminals have been strongly demanded for size reduction, so that the arrangement of keyboards, if necessary, has to satisfy the demand for size reduction of main bodies themselves.

In consideration thereabove, portable information terminals having keyboards that are exposed for use have been developed and are on the market today. Namely, the terminal main of each of these portable information terminals is made up of two housings. One of the housings is slidingly arranged for the other in a predetermined direction. When the terminal body is put by this sliding operation into an open status, the keyboard is exposed for use. This configuration allows the use of the keyboard on an as desired basis while satisfying the demand for terminal size reduction.

On the other hand, today, the increased speeds of processors and the increased sizes of memories that are mounted on portable information terminals allow the simultaneous execution of two or more applications. For example, users are able to make chat while reproducing desired music on music players, such as MP3 (MPEG Audio Layer-3) players incorporated in portable information terminals. In such a use form, it is desired that, while entering text for chat through the keyboard, commands, such as fast feed and rewind be given to the incorporated music player. Namely, it is desired that interrupt processing associated with desired operations be executed in a simple and prompt manner as timely as possible.

For example, Japanese Patent Laid-Open No. 2001-202166 discloses an information processing mechanism in which, if a command for reproducing an information recording media is detected when a portable personal computer is in a suspended mode, namely, when the CPU of this portable personal computer is in a stopped status, then a interrupt signal is outputted to the CPU to make the CPU execute the reproduction of the information recording media.

### SUMMARY OF THE INVENTION

However, according to the configuration in which the keyboard is exposed for use when the body of a portable information terminal is opened by sliding as with the above-mentioned related technique, the keyboard becomes appropriately usable while satisfying the demand for terminal's size reduction; but, if special keys for the user to give desired commands are to be separately arranged, it is necessary to contrive the arrangement of these special keys on the basis of the above-mentioned demand for size reduction and the above-mentioned opening/closing configuration by sliding.

Further, a so-called QWERTY keyboard of often used for the keyboard of the portable information terminal, so that the arrangement of the special keys has to be contrived in consideration of the specialty of the QWERTY keyboard.

Besides, because two or more applications can now be executed at the same time, it is desired to make the special keys have various functions according to this execution mode.

Therefore, the embodiment of the present invention addresses the above-identified and other problems associated with related-art methods and apparatuses and solves the addressed problems by providing a portable information terminal arranged with special keys having a plurality of functions at suitable positions from the viewpoint of the specialty of the QWERTY keyboard and the effective use of a space of the terminal itself, thereby satisfying various user needs.

In carrying out the invention and according to a first mode thereof, there is provided a portable information terminal in which a second housing is slidingly arranged for a first housing. This portable information terminal has an operation key arranged on a plane of the second housing that is exposed when the second housing is put in an open status relative to the first housing by a sliding movement in one direction; and a special key arranged in a predetermined area on another direction side opposite to the one direction on the plane.

The above-mentioned novel configuration enhances the ease of operation of the special key.

It should be noted that the above-mentioned predetermined area may be an area that is provided as a result of leaving the requisite minimum of QWERTY keys making up the QWERTY keyboard and removing other keys. Alternatively, the above-mentioned predetermined area may be an area that is operable without making the second housing fully open relative to the first housing by sliding. The above-mentioned special key may be shaped so as to reduce the height of the special key as compared with each QWERTY key making up the QWERTY keyboard. Alternatively, the height of the special key from the above-mentioned plane may be different from that of each QWERTY key making up the QWERTY keyboard. The special key may be illuminated by a light-emitting element in a color different from that of each QWERTY key making up the QWERTY keyboard. It is also practicable to provide a control section configured to execute two or more applications and change types of the command signal that are outputted when the special key is pressed in cooperation with an application executed by the control section.

In carrying out the invention and according to a second mode thereof, there is provided a portable information terminal capable of reproducing desired music by executing an application associated with a music player and registering a title of music beforehand. This portable information terminal has a display section configured to display a screen associated with the executed application; an application identification section configured to identify a type of the executed application; and a display control section configured to at least display the registered title of music being reproduced by the music player if concurrent execution of the application associated with the music player and a predetermined application has been determined by the application identification section.

The above-mentioned novel configuration allows additional functions, such as the displaying of mood messages, to be reflected on the results of the execution of the above-mentioned predetermined application.

In carrying out the invention and according to a third mode thereof, there is provided a portable information terminal capable of browsing content. This portable information terminal has an application identification section configured to identify a type of an executed application; a key operation detection section configured to detect an operation of a special key; and a status display control section configured to at least display a registered title of music being reproduced by the music player when the operation of the special key is detected by the key operation detection section if concurrent execution of the application associated with the music player and a predetermined application has been determined by the application identification section.

The above-mentioned novel configuration allows the confirmation of statuses any time by the operation of the special key.

As described and according to the embodiment of the invention, various needs by users can be satisfied by arranging, in the employment of a QWERTY keyboard, special keys having different functions at a suitable position from the viewpoint of the specialty of the keyboard and the effective use of space on a terminal itself.

### BRIEF DESCRIPTION OF THE DRAWINGS

FIG. 1 is a schematic diagram illustrating a configuration of a portable information terminal practiced as a first embodiment of the invention;

FIGS. 2A, 2B and 2C are diagrams illustrating status transitions of a portable information terminal 1 that accompany slide operations;

FIG. 3 is a block diagram illustrating an internal configuration of the portable information terminal 1 practiced as the first embodiment of the invention;

FIG. 4A shows a menu screen;

FIG. 4B shows a music play operating screen;

FIG. 4C shows an announce screen of music being reproduced;

FIG. 5 is a conceptual diagram illustrating a configuration for executing processing characteristic to a portable information terminal practiced as a second embodiment of the invention;

FIG. 6 is a flowchart indicative of the processing characteristic to the portable information terminal practiced as the second embodiment of the invention;

FIG. 7 shows an operation screen that is displayed when an application associated with chat is started up;

FIG. 8 is a conceptual diagram illustrating a configuration for executing processing characteristic to a portable information terminal practiced as a third embodiment of the invention;

FIG. 9 is a flowchart indicative of the processing characteristic to the portable information terminal practiced as the third embodiment of the invention; and

FIG. 10A and FIG. 10B show operation screens that are displayed when an application associated with Rss/Podcast is started up.

### DETAILED DESCRIPTION OF THE PREFERRED EMBODIMENTS

This invention will be described in further detail by way of best modes (hereafter simply referred to as embodiments) thereof with reference to the accompanying drawings.

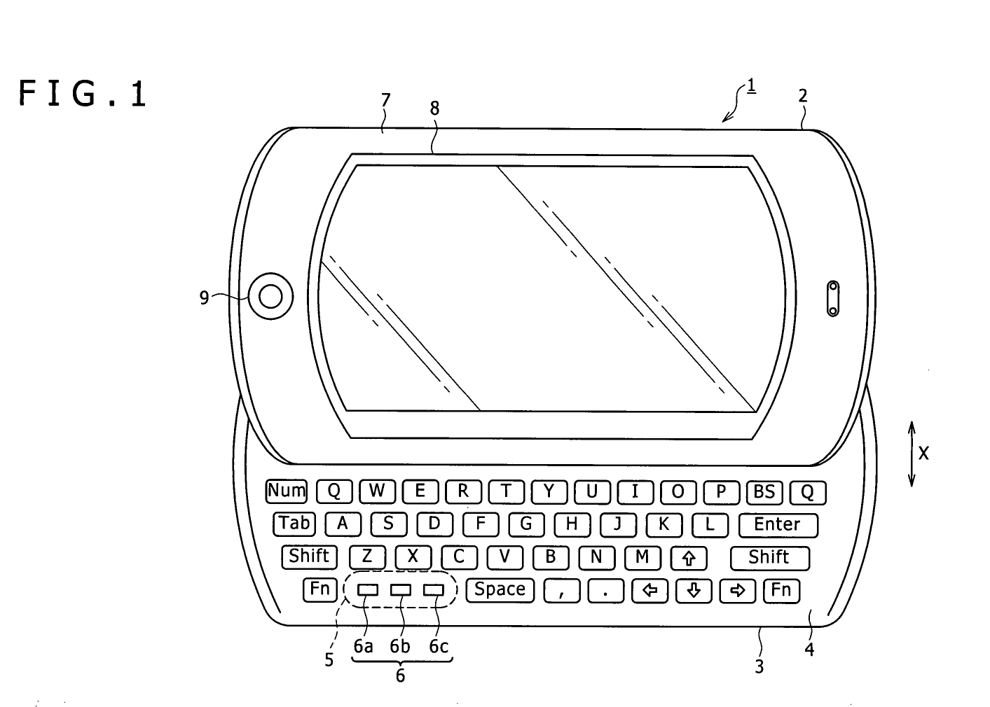

Now, referring to FIG. 1, there is shown a configuration of a portable information terminal practiced as a first embodiment of the invention.

As shown in FIG. 1, with a portable information terminal 1, a first housing 2 is slidingly arranged for a second housing 3 in a direction indicated by arrow X shown in FIG. 1, namely, arranged in an opening/closing manner.

On a plane 7 of the first housing 2, a touch screen 8 integrally made up of an LCD (Liquid Crystal Display) and a touch panel and a power button 9 are arranged.

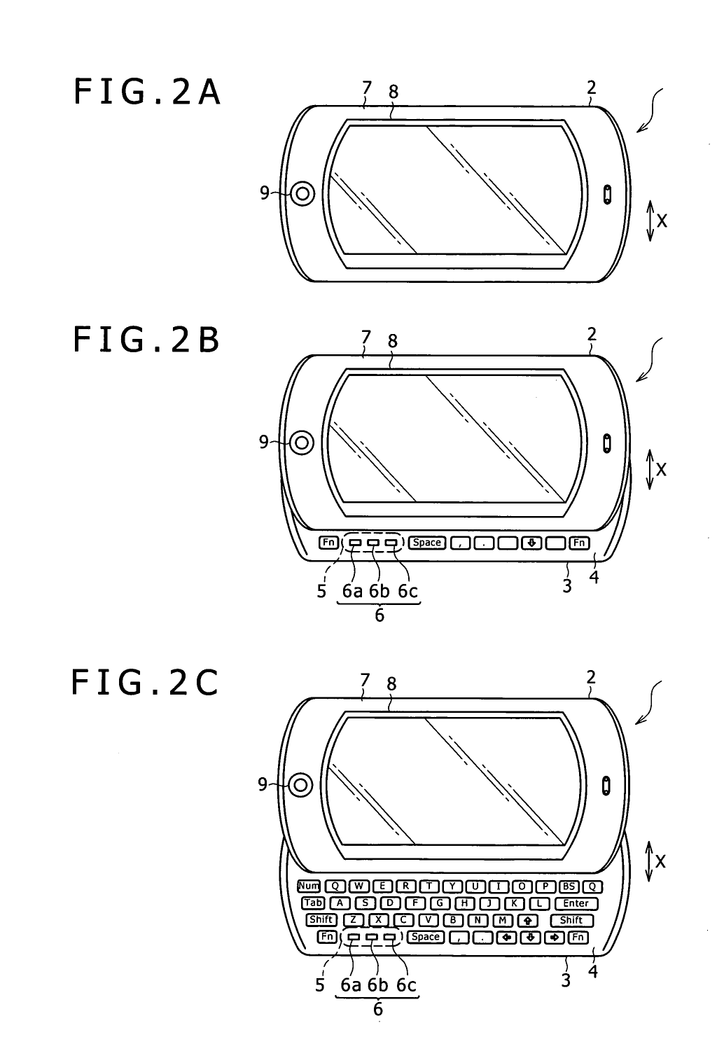

Status transitions of the portable information terminal 1 that accompany this sliding operation are as shown in FIGS. 2A through 2C. Namely, to be more specific, FIG. 2A shows the portable information terminal 1 in a closed status, FIG. 2B shows the portable information terminal 1 in a partially open status, and FIG. 2C shows the portable information terminal 1 in an opened status.

A plane 4 that is exposed when the second housing 3 of the portable information terminal 1 is in the opened status is arranged with a keyboard of so-called QWERTY key matrix (hereafter referred to as a “QWERTY keyboard”). An area 5 of the plane 4 is arranged with a special key 6 (6a, 6b, and 6c).

In what follows, it is assumed that the QWERTY keyboard be configured by QWERTY keys and other keys including Enter and Shift keys.

For example, if music is being reproduced by an incorporated music player, the special key 6a is used to issue a command for rewind, the special key 6b is used to issue a command for play/pause, and the special key 6c is used to issue a command for fast feed. In addition, the special key 6 also functions to issue a command for executing interrupt processing associated with display status, details thereof being described later.

With the portable information terminal 1 according to the first embodiment, the arrangement of the special key 6 is contrived as shown below in the configuration where the second housing 3 slides relative to the first housing 2.

1. Contrivance for Ease of Operation of the Special Key 6

Namely, users who routinely operate personal computers are familiar with keyboards of QWERTY arrangement, so that it is not possible to change this arrangement. In such a situation, of the keys of the QWERTY keyboard adopting QWERTY arrangement, merely those keys that are requisite minimum are left in consideration of the use condition of portable information terminals, the other keys being removed. In a space provided by the removal, the special key 6 is arranged. In this example, keys including “CTRL”, “ALT”, and “Not Convert” are considered to be unnecessary for portable information terminals from the viewpoint of requisite minimum. An area 5 provided by removing these keys is arranged with the special key 6.

2. Contrivance for Opening/Closing Configuration by Sliding

For example, in a situation where the music player is started and music is being reproduced, the QWERTY keyboard is not typically operated, so that it is desired to operate the portable information terminal in a closed status. On the other hand, in the case of the terminal 1 on which two or more applications are executable, it is desired to execute operations, such as fast feeding music, while entering text for chat, for example. Therefore, in the configuration of the opening/closing by sliding, the special key 6 is arranged in the area 5 provided in the lower left of the plane 4 of the second housing 3 so as to satisfy the both operation requirements.

When the special key 6 is arranged in the area 5, in the open status (refer to FIGS. 1 and 2C), the special key 6 can be operated as desired to rewind or fast feed the music player being reproduced while operating the QWERTY keyboard to enter text for chat, for example. Even in the partially open status (refer to FIG. 2B), the special key 6 can be operated, so that, if the portable information terminal 1 is in a bag or a cloth pocket and a command for music fast feed or rewind is given, the command can be easily and quickly issued in the partially open status without fully open the second housing 3 relative to the housing 2 by sliding.

3. Other Contrivances

In addition to the above-mentioned contrivances, it is also practicable to make the shape of the special keys 6 horizontally aligned in the area 5 different from the shape of the other keys, thereby making it possible for the user to identify the special keys 6 without looking thereat. In the example shown in FIG. 1, each of the special keys 6 are shaped thinner in vertical direction than the other keys to make difference. Obviously, the shape of the special key 6 is not limited to this shown shape.

It is also practicable to make difference by making the projection height from the plane 4 of the second housing 3 different from that of the other keys, using a back light, such as an light-emitting element, in each of the special keys 6 to emit light of different color than that of the other keys, or using a click feeling different from that of the other keys.

Consequently, the special key 6 can be arranged at a suitable position also from the viewpoint of ease of operation and the contrivance for preventing an operation error by considering visual effect can be added. Further, in such a product desired for size reduction as a portable information terminal, the space thereof can be sufficiently utilized without impairing related-art functions.

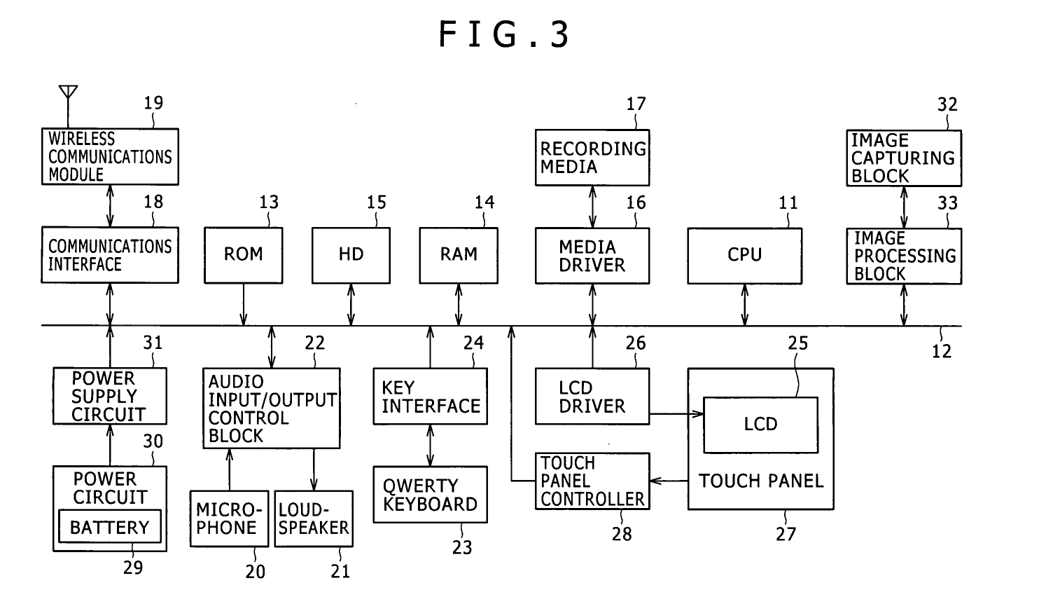

The following describes an internal configuration of the portable information terminal 1 practiced as the first embodiment of the invention with reference to FIG. 3. As shown in FIG. 3, a CPU (Central Processing Unit) 11 controlling the entire terminal is communicably connected to a ROM (Read Only Memory) 13, a RAM (Random Access Memory) 14, and a HD (Hard Disc) 15 via a control bus 12. In the ROM 13, a control program is stored in advance. The CPU 11 reads and executes this control program. At this moment, the RAM 14 functions as a work area. In the HD 15, data, such as various kinds of content including music and images, are stored. It should be noted that a flash memory can be used in place of this HD 15.

The CPU 11 is also connected, via the control bus 12, to media driver 16 for controlling read/write operation on a recording media 17, a communications I/F 18 for serial/parallel converting communications data from a wireless communications module 19 and outputting the converted data, an audio input/output block 22 for controlling audio output from a microphone 20 and audio output through a loudspeaker 21, and a key I/F 24 for outputting a signal corresponding to each operation key of a QWERTY keyboard 23.

Further, the CPU 11 is connected, via the control bus 12, to an image processing block 33 for performing predetermined image processing on a video signal taken by an image capturing block 32.

The CPU 11 is still further communicably connected, via the control bus 12, to an LCD driver 26 for drivingly controlling an LCD 25 and a touch panel controller 28 for outputting a signal when a touch panel 27 is operated. These LCD 25 and touch panel 27 make up the touch screen 8. In addition, the power from a power circuit 30 having a battery 29 is supplied from a power supply circuit 31 to each component block.

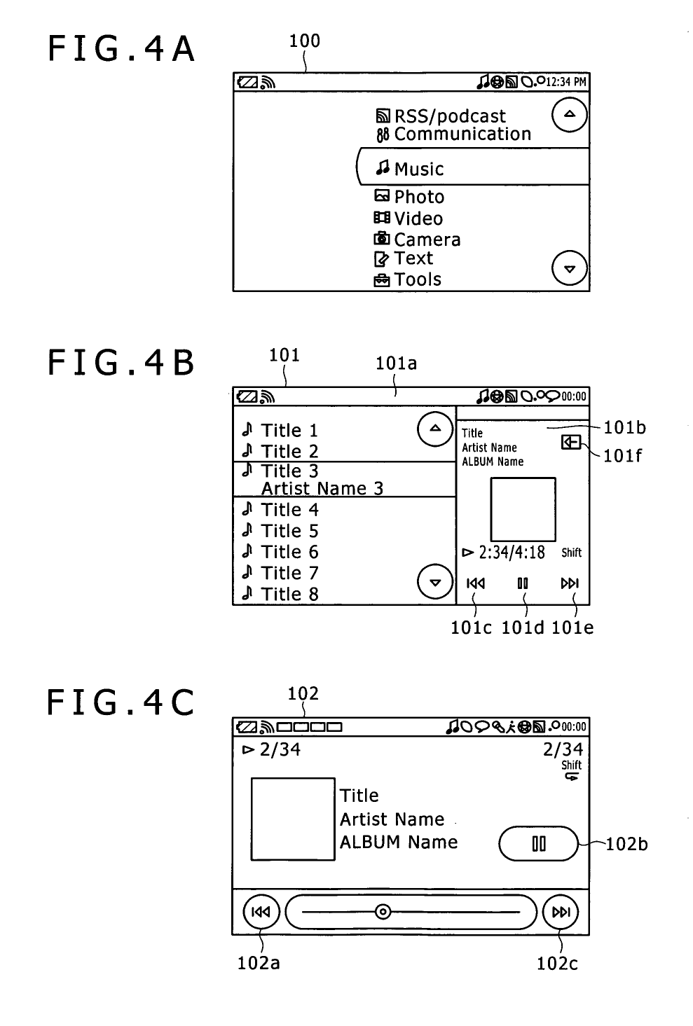

In the above-mentioned configuration, when the power button 9 is turned on, the power is supplied from the power circuit 30 to each component block through the power supply circuit 31. Then, the CPU 11 reads the control program from the ROM 13 and executes the control program, thereby starting control on each component block. Namely, the CPU 11 drivingly controls the LCD 25 via the LCD driver 26 to display a menu screen (an initial screen) onto the LCD 25. This menu screen is shown in FIG. 4A, for example.

Namely, on a menu screen 100 displayed on the LCD 25, the user can select a desired application from “RSS/Podcast” for browsing content distributed from RSS/Podcast, “Communication” for electronic mail distribution and chat, “Music” for reproducing music, “Photo” for reproducing images, “Video” for reproducing video content, “Camera” for taking pictures, “Text” for entering text, and “Tools” for executing other tools than mentioned above.

When “Music” is tapped through the touch panel 27, for example, a screen 101 displayed in FIG. 4B is shown.

Namely, in a left area 101a of the screen 101, music names (or titles) are selectably listed; in a right area 101b, details (title, artist name, album name, and jacket image) of music corresponding to a title selected by tapping are displayed. Further, below the left area 101b, a button 101c for commanding rewind, a button 101d for commanding play/pause, and a button 101e for commanding fast feed are displayed. In addition, a button 101f is displayed so as to full-screen display the display in the left area 101b.

When a button 101f is tappingly selected on the touch panel 27 in the screen 101 shown in FIG. 4B, the screen 102 shown in FIG. 4C appears.

Namely, on the screen 102, the details (title, artist name, album name, and jacket image) of music are displayed in a zoom-in manner (approximately full-screen display in the right area 101b of the screen 101b). Further, on the screen 102, a button 102a for commanding rewind, a button 102b for commanding play/pause, and a button 102c for commanding fast feed are displayed.

When a desired title is selected and commanded for reproduction through the above-mentioned screens 100 through 102, the music is outputted from the loudspeaker 21 via the audio input/output block 22 under the control of the CPU 11. At this moment, the commands given by the buttons 101c, 101d, and 101e on the screen 101 and the buttons 102a, 102b, and 102con the screen 102 can be alternately given by the above-mentioned special keys (reference numeral 6 shown in FIG. 1 (6a, 6b, and 6c).

When “Photo” is tapped on the screen 100 by operating the touch panel 27, still image data recorded to the HD 15 or the recording media 17 is made ready for reproduction. The CPU 11 reads the still image data compressed by JPEG (Joint Photographic Coding Experts Group) for example from the HD 15 or the recording media 17, decodes this still image data by software processing, and drivingly controls the LCD 25 through the LCD driver 26, thereby reproducing a moving image. When “Video” is tapped on the screen 100, moving data recorded to the HD 15 or the recording media 17 becomes ready for reproduction. The CPU 11 reads the moving image data compressed by MPEG (Motion Picture Experts Group) for example from the HD 15 or the recording media 17, decodes this moving data by software processing, and drivingly controls the LCD 25 through the LCD driver 26, thereby reproducing the moving image.

Further, when “Camera” is tapped on the screen 100 by operating the touch panel 27, a subject is made ready for shooting through the image capturing block 32. The image processing block 33 performs predetermined image processing on an image signal obtained through the image capturing block 32 and outputs the processed data as image data. The CPU 11 compresses the image data by JPEG by software processing and records the compressed image data to the HD 15 or to the recording media 17 via the media driver 16. When “Text” is tapped on the screen 100 by operating the touch panel 27, a text input screen appears on the LCD 25, making it ready for entering text through the QWERTY keyboard 23.

On the other hand, when “RSS/Podcast” is tapped by operating the touch panel 27, an RSS/Podcast browse screen appears on the LCD 25, thereby making it ready for selecting and browsing titles of updated content, for example.

“RSS” denotes an XML-based format for describing metadata such as Web site headers and summaries in a structured manner, RSS being mainly used for publicizing the update information of Web sites. A document written by RSS can be written with Web site page title, address, header, summary, and updated time, for example. With this portable information terminal 1, the registered update information of a Web site distributed from a feed by RSS is automatically received by the wireless communications module 19 every time most recent broadcast contents are made public and the automatically received updated information is stored in the HD 15, so that desired content can be browsed by tapping the title of that content on the RSS/Podcast browse screen by operating the touch panel 27. “Podcast” denotes a system in which so-called net radio programs are automatically recorded and recorded programs can be heard when desired. With this portable information terminal 1, the address of a desired net radio station is registered, the most recent broadcast is automatically received by the wireless communications module 19, and the received broadcast is stored in the HD 15, so that the user can appropriately hear desired content by selecting the title thereof on an RSS/Podcast browse screen by operating the touch panel 27.

On the other hand, when “Communication” is tapped for selection by operating the touch panel 27, chat and Skype, for example, become ready for use. In this case, the user can enter his ID/PASS and chat send messages by operating the QWERTY keyboard 23; in detail, mood messages to be described later can be entered.

By the above-mentioned selection, the operation of special keys (reference numeral 6 shown in FIG. 1) appropriately allows music rewind, play/pause, and fast feed even during the reproduction of still images or moving images, the entry of text, and the browsing of update information of RSS/Podcast.

As described above, according to the first embodiment of the invention, in the portable information terminal 1 on which the second housing 3 is slidingly arranged for the first housing 2, a QWERTY keyboard and the special key 6 are arranged on the plane 4 of the second housing 3 that is exposed when the second housing 3 is opened relative to the first housing 2 by this sliding. In detail, this special key 6 may be arranged in the area 5 that is provided by leaving the requisite minimum keys of the QWERTY keys and removing other keys.

Therefore, according to the first embodiment of the invention, in the portable information terminal strongly demanded for size reduction, user convenience can be enhanced while effectively utilizing the space.

Because the special key is arranged in this area 5, the special key 6 becomes operable without fully opening the second housing 3 by sliding the second housing 3 relative to the first housing 2.

Consequently, the ease of operation by the user, especially, the ease of operation by the user on the move is enhanced.

Further, as compared with QWERTY keys making up the QWERTY keyboard, the special key 6 may be shorter in the vertical direction, resulting in a wide rather than long shape or different in the height from the plane 4 from QWERTY keys making up the QWERTY keyboard. Alternatively, the special key 6 may be back-lighted with a light-emitting element, such as a LED, to be illuminated in a different color than that of QWERTY keys making up the QWERTY keyboard.

According to the above-mentioned contrivances, the difference of the special key 6 from other keys can be increased for enhanced ease of operation.

The following describes a second embodiment of the invention.

In the past, Skype that is one of voice communications software programs, can display mood messages. In this case, clicking a button of account name displays a mood message input box in which a desired mood message can be entered. A portable information terminal practiced as this second embodiment can display the registered title, for example, of music being reproduced as a mood message when a predetermined application is being executed, not exclusive to Skype.

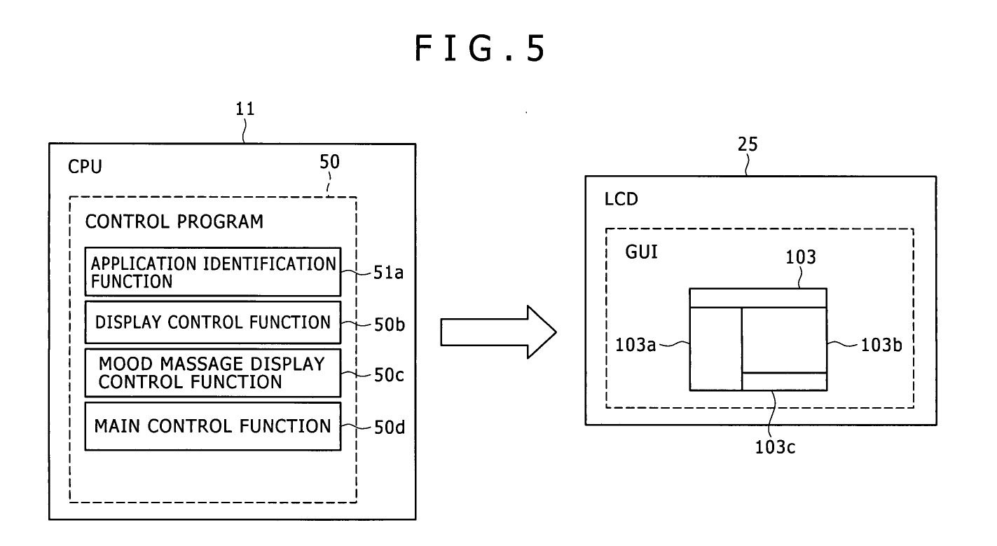

Referring to FIG. 5, there is shown a conceptual configuration for executing processing characteristic to the portable information terminal associated with the second embodiment of the invention. As shown in FIG. 5, a CPU 11 executes a control program 50 to provide an application identification function 50a, a display control function 50b, a mood message display control function 50c, and a main control function 50d. Namely, when the CPU 11 executes these functions 50a through 50d, the CPU 11 plays roles of an application identification section, a display control section, a mood message display control section, and a main control section, for example.

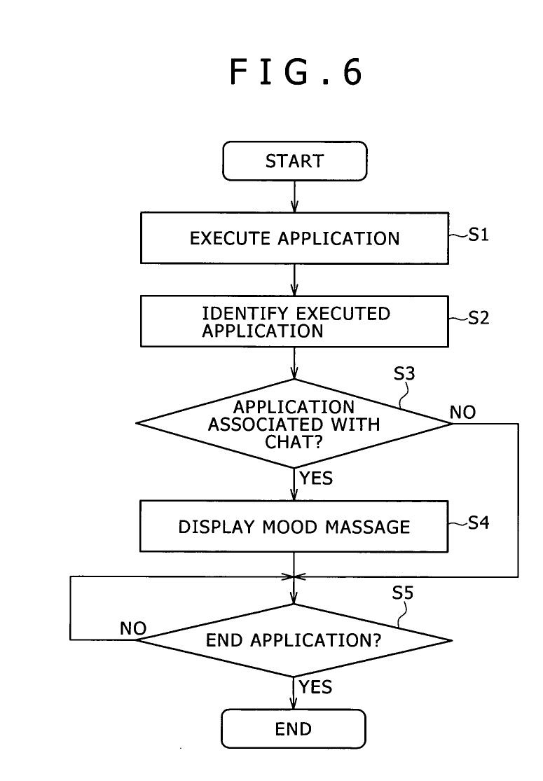

The following describes the characteristic processing with reference to the flowchart shown in FIG. 6.

Executing an application (step S1), the CPU 11 identifies the application identified by the application identification function 50a (step S2). As this application is executed, a screen 103 is displayed on an LCD 25.

For example, as shown in FIG. 5, a chat member list is displayed in a left area 103a of the screen 103 and a chat progress information is displayed in a right area 103b.

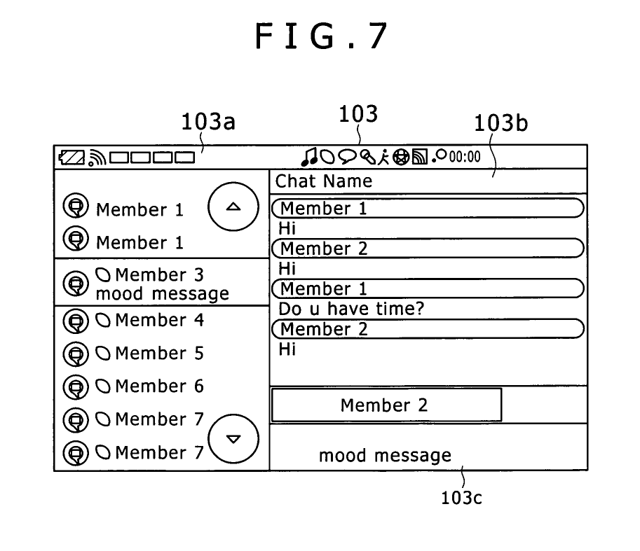

In detail, as shown in FIG. 7, a chat member list containing member 1, member 2 . . . , for example, is displayed in the left area 103a of the screen 103 and the identification of member who has written and the contents of writing are displayed in time-dependent manner in the right area 103b.

Next, the CPU 11 determines whether a chat-associated application that is a predetermined application has been executed by the main control function 50d (step S3).

If the chat-associated application is found not executed (No in step S3), the procedure goes to step S5. On the other hand, if the chat-associated application is found executed (Yes in step S3), a mood message is displayed on an LCD 25 by the mood message display control function 50c (step S4).

For example, in the example shown in FIG. 5, a mood message is shown in a mood message display area 103c of the screen 103. In detail, as shown in FIG. 7, user identification and a mood message are displayed together in the mood message display area 103c.

Because a situation is assumed here in which music reproduction by the music player is executed along with the execution of the chat-associated application, a registered music name (a title) associated with the music being reproduced is displayed as a “mood message”. It should be noted that, as shown in FIG. 7, for those members who have permitted the display of mood messages, the mood messages of those members are also displayed in the area 103a.

As described above, the CPU 11 determines whether the application has been ended by the main control function 50d (step S5). If the application is found ended (Yes in step S5), the above-mentioned sequence of processing comes to an end.

If a title change occurs by fast forwarding the music being reproduced in the process of the above-mentioned exemplary sequence of processing, then the display of mood message is updated by an interrupt processing. This also holds true if a rewind, play/pause, or fast feed is made on the music being reproduced by the operation of the special key (reference numeral 6 shown in FIG. 1) of the QWERTY keyboard.

As described above, according to the second embodiment of the invention, if the CPU 11 determines by the execution of the control program 50 that an application associated with the music player and a predetermined application (for example, a chat-associated application) have been executed in parallel by the application identification function 50a, then a registered title associated with the music being reproduced by the music player can be at least displayed on the LCD 5 as a mood message by the mood message display control function 50c.

Therefore, the user can appropriately confirm the title of the music being reproduced by himself while making chat, for example, and tell chat members this confirmation as a mood message, thereby smoothing the communications between the chat members.

The following describes a third embodiment of the invention.

In the third embodiment, if a special key (equivalent to reference numeral 6 shown in FIG. 1) is pressed during the execution of a predetermined application, the registered music name (title) for example of the music being reproduced by the music player along with the execution of the predetermined application, namely, “status” of the music player, such as reproduction, is displayed. The following described details thereof.

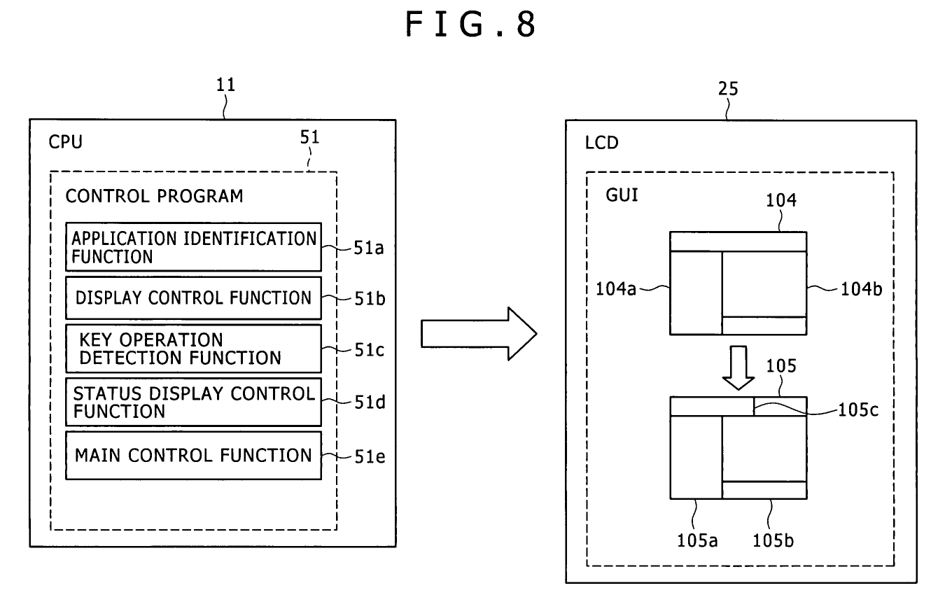

Referring to FIG. 8, there is shown a schematic configuration for executing processing characteristic to a portable information terminal associated with the third embodiment of the invention. A CPU 11 executes a control program 51 to play roles of an application identification function 51a, a display control function 51b, a key operation detection function 51c, a status display control function 51d, and a main control function 51e. Namely, when the CPU 11 plays roles of the functions 51a through 51e, the CPU 11 functions as the application identification section, the display control section, the key operation detection section, the status display control section, and the main control section.

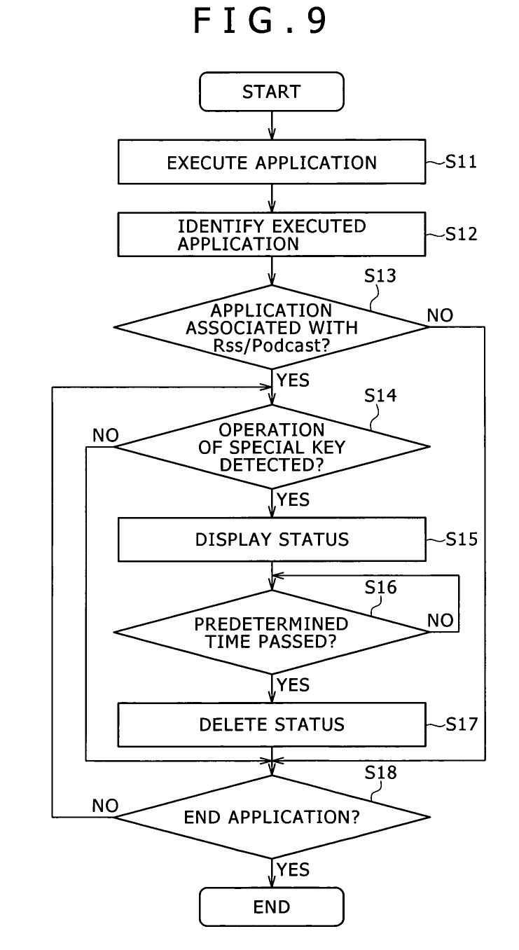

The following describes the above-mentioned characteristic processing with reference to the flowchart shown in FIG. 9.

Executing an application (step S11), the CPU 11 identifies an application executed by the application identification function 51a (step S12). When this application is executed, a screen 104 is displayed on an LCD 25.

For example, if an RSS/Podcast application is executed, the screen 104 shown in FIG. 5 is displayed on the LCD 25 by the display control function 51b of the CPU 11. In a left area 104a of the screen 104, a feed list registered with RSS/Podcast is displayed; in a right area 104b, a title list, such as distributed articles, is displayed.

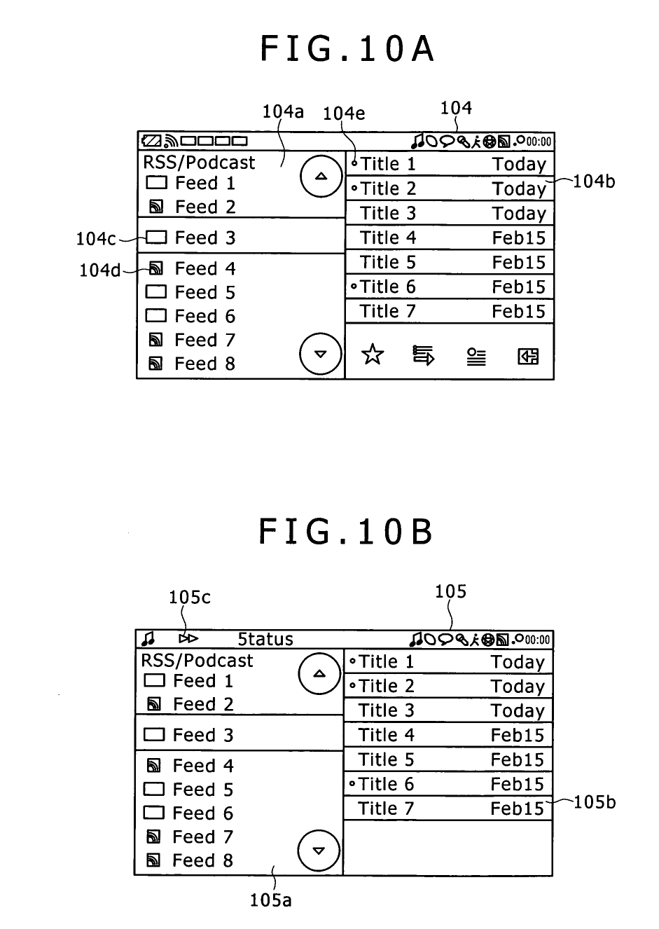

In detail, as shown in FIG. 10A, a list of registered feeds is displayed, as feed1, feed2, . . . in the left area 104a of the screen 104 and the titles of distributed articles associated with feeds selected by tapping in the left area 104a are displayed as title1, title2, . . . in the right area 104b. In addition, a mark 104c is indicative of the number of unread items of content among pieces of content, such as distributed articles and a mark 104d is indicative that there is no unread content. A mark 104e is indicative that the content having the title concerned is unread.

Next, the CPU 11 determines whether an RSS/Podcast application that is a predetermined application, for example, has been executed by the main control function 50d (step S13). If the RSS/Podcast application is found not executed (No in step S13), then the procedure goes to step S18; if the RSS/Podcast application is found executed (Yes in step S13), then the CPU 11 determines whether the operation of a special key (equivalent to reference numeral 6 shown in FIG. 1) has been detected by the key operation detection function 51c (step S14).

If the operation of the special key is found not detected, then the procedure goes to step S18. On the other hand, if the operation of the special key is found detected, then a status is displayed by the status display control function 51d (step S15). This status is kept displayed until a predetermined time passes (step S16). When the predetermined time has passed (Yes in step S16), the status is deleted (step S17).

For example, in the example shown in FIG. 8, the status is displayed in a status display area 105c of a screen 105. In detail, as shown in FIG. 10B, a registered music name (title) associated with the music being reproduced is displayed in the status display area 105c.

At this moment, obviously, as with the above-described screen 104, a list of feeds is displayed as feed1, feed2, . . . , in the left area 105a of the screen 105 and titles of distributed articles associated with feeds tapped in the left area 105a for selection are displayed as title1, title2, . . . , in a right area 105b.

Thus, the CPU 11 determines whether the end of the application has been detected by the main control function 50d (step S18). If the end of the application is found not ended (No in step S18), then the procedure returns to step S14 to repeat the above-mentioned processing therefrom. On the other hand, if the end of the application is found detected (Yes in step S18), then the sequence of processing comes to an end.

As described above, according to the third embodiment of the invention, in the portable information terminal capable of browsing content, if the operation of the special key is detected by the key operation detection function 51c when an application associated with the music player and a predetermined application (for example, Rss/Podcast) have been executed in parallel by the application identification 51a by executing the control program 51 by the CPU 11, the registered music name associated with the music being reproduced by the music player can be displayed on the LCD 25 as a status by the status display control function 51d. Therefore, appropriately pressing the special key (reference numeral 6 shown in FIG. 1) during the execution of a predetermined application, Rss/Podcast for example, allows the user to easily and quickly confirm the title of the music being reproduced by the music player as a status.

While preferred embodiments of the present invention have been described using specific terms, such description is for illustrative purpose, and it is to be understood that changes and variations may be made without departing from the spirit or scope of the following claims.

For example, operating the special key during Web browsing allows the changing (rewind/browse/feed) of content to be browsed, from time to time. In addition, the embodiments of the invention are obviously applicable also to moving image display apparatuses and apparatuses for browsing still images.

1. A portable information terminal in which a second housing is slidingly arranged for a first housing, comprising:
an operation key arranged on a plane of said second housing that is exposed when said second housing is put in a first open status relative to said first housing by a sliding movement in one direction; and
a special key arranged in a predetermined area on another direction side opposite to said one direction on said plane.

2. The portable information terminal according to claim 1, wherein said operation key is a QWERTY key.

3. The portable information terminal according to claim 1, wherein said predetermined area is an area that becomes operable when said second housing is put in a second open status in which a portion of said plane to be exposed is smaller than in said first open status relative to said first housing by a second sliding movement.

4. The portable information terminal according to claim 1, wherein said special key has a shape different from that of said operation key.

5. The portable information terminal according to claim 1, wherein said special key is different in height from said plane than said operation key.

6. The portable information terminal according to claim 1, wherein said special key is illuminated by a light-emitting element in a color different from that of said operation key.

7. The portable information terminal according to claim 1, further comprising:
control means configured to execute a plurality of applications,
said special key outputting a command signal corresponding to each application executed by said control means.

8. A portable information terminal capable of reproducing desired music by executing an application associated with a music player and registering a title of music beforehand, comprising:
display means for displaying a screen associated with the application;
application identification means for identifying a type of the application; and
display control means for at least displaying the title of music being reproduced by said music player if concurrent execution of said application associated with said music player and a predetermined application has been determined by said application identification means.

9. A portable information terminal capable of browsing content, comprising:
application identification means for identifying a type of an executed application;
key operation detection means for detecting an operation of a special key; and
status display control means for at least displaying a registered title of music being reproduced by said music player when said operation of said special key is detected by said key operation detection means if concurrent execution of said application associated with said music player and a predetermined application has been determined by said application identification means.

10. A portable information terminal capable of reproducing desired music by executing an application associated with a music player and registering a title of music beforehand, comprising:
a display unit configured to display a screen associated with the application;
an application identification unit configured to identify a type of the application; and
a display control unit configured to at least display the title of music being reproduced by said music player if concurrent execution of said application associated with said music player and a predetermined application has been determined by said application identification means.

11. A portable information terminal capable of browsing content, comprising:
an application identification unit configured to identify a type of an executed application;
an key operation detection unit configured to detect an operation of a special key; and
an status display control unit configured to at least display a registered title of music being reproduced by said music player when said operation of said special key is detected by said key operation detection means if concurrent execution of said application associated with said music player and a predetermined application has been determined by said application identification means.
